(19) United States
(12) Patent Application Publication
(10) Pub. No.: US 2017/0310554 A1
(43) Pub. Date: Oct. 26, 2017

(54) Network Virtualization

(71) Applicant: Hewlett Packard Enterprise Development LP, Houston, TX (US)

(72) Inventors: Jianfeng LIU, Beijing (CN); Min YAO, Beijing (CN)

(21) Appl. No.: 15/512,850

(22) PCT Filed: Sep. 21, 2015
(86) PCT No.: PCT/CN2015/090074

§ 371 Date: Mar. 21, 2017

(30) Foreign Application Priority Data
Sep. 22, 2014 (CN) 201410487032.9

(51) Int. Cl. H04L 12/24; H04L 12/46; H04L 12/54; H04L 12/00

(52) U.S. Cl. CPC H04L 41/12; H04L 41/50; H04L 12/56; H04L 12/4641; H04L 12/00; H04L 41/00

(57) ABSTRACT

A virtualization controller may select a physical device as a root device of a virtual device, and select a physical device as a leaf device of the virtual device. The virtualization controller may obtain a user network interface (UNI) on the leaf device, establish a virtual interface on the root device for the UNI, and record a relation which associates the UNI with the virtual interface. The virtualization controller may control the root device and the leaf device to establish a virtual tunnel between the UNI and the virtual interface through which the root device and the leaf device may exchange data.

### BACKGROUND

Network virtualization includes horizontal (or scale-out) virtualization and vertical (or scale-up) virtualization. Horizontal virtualization refers to connecting plural devices at the same level of the network, for example at the aggregation layer, through specific links to form one logical device. The logical device may be referred to as a virtual device. The virtual device may be managed as a single device and forward traffic as if it was a single device, despite comprising a plurality of physical devices. In this way the virtualization may facilitate redundancy and load balancing. Horizontal virtualization techniques include for example intelligent resilient framework (IRF) 2.0. virtual switching system (VSS), cluster switch system (CSS), virtual chassis, and the like. Vertical virtualization refers to stacking devices at different levels of the network, for example at both access and aggregation layers, to form one logical virtual device. Vertical virtualization techniques include IRF 3.0, virtual converged framework (VCF), fabric extender (FEX), 802.1br, and the like. For example, aggregation layer switches may be a core of the virtual device and access layer switches may be integrated into the virtual device by acting as remote interface boards to extend input-output (I/O) capacities of the logical virtual device.

### BRIEF DESCRIPTION OF THE DRAWINGS

Features of the present disclosure are illustrated by way of example and not limited in the following figures, in which like numerals indicate like elements, in which:

FIG. 1 is a flowchart illustrating a network virtualization method in accordance with an example of the present disclosure:

FIG. 2 is a flowchart illustrating a network virtualization method in accordance with an example of the present disclosure;

FIG. 3 is a schematic diagram illustrating virtual devices in accordance with an example of the present disclosure;

FIG. 4 is a schematic diagram illustrating a virtual device in accordance with an example of the present disclosure;

FIG. 5 is a schematic diagram illustrating a structure of a virtualization controller which includes a network virtualization apparatus in accordance with an example of the present disclosure:

FIG. 6 is a flowchart illustrating a network virtualization apparatus in accordance with an example of the present disclosure;

FIG. 7 is a schematic diagram illustrating a structure of a root device which includes a network virtualization apparatus in accordance with an example of the present disclosure;

FIG. 8 is a flowchart illustrating a network virtualization apparatus in accordance with an example of the present disclosure.

### DETAILED DESCRIPTIONS

For simplicity and illustrative purposes, the present disclosure is described by referring to examples thereof. Rather, these examples are provided so that this disclosure will satisfy applicable legal requirements. In the following description. numerous specific details are set forth in order to provide a thorough understanding of the present disclosure. In other instances, some methods and structures have not been described in detail so as not to unnecessarily obscure the present disclosure. As used herein, the term “includes” means includes but not limited to, the term “including” means including but not limited to. The term “based on” means based at least in part on. The term “comprise” and its variations mean at least comprise but not limited to, i.e., besides the features listed, other features may also exist. Quantities of an element, unless specifically mentioned, may be one or a plurality of, or at least one.

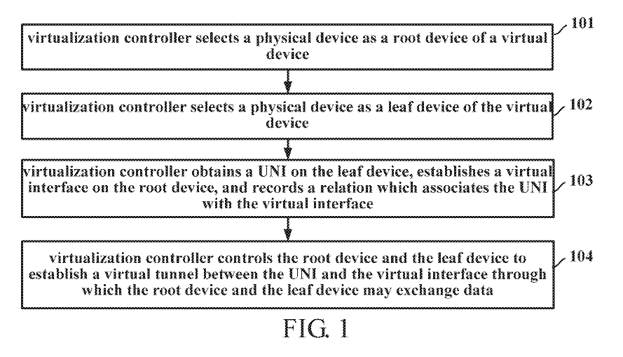

FIG. 1 is a flowchart illustrating a network virtualization method in accordance with an example of the present disclosure. The method may include the following procedures.

At block 101, a virtualization controller may select a physical device as a root device of a virtual device. The virtualization controller may select one or plural physical devices, and each of the selected one or plural physical devices may serve as a root device of the virtual device

The root device refers to a device for exchanging information with the network for a user, and serves as an information forwarding center of the virtual device and an interface of the virtual device to the network. The information may include information sent by a user or sent to the user. The information may include data packets, signaling messages, or the like. The root device may make forwarding decisions for packets received from the user. The root device may be a physical device or a logical device formed by plural physical devices in the network.

At block 102, the virtualization controller may select a physical device as a leaf device of the virtual device. The virtualization controller may select one or plural physical devices, and each of the selected one or plural physical devices may serve as a leaf device of the virtual device.

In an example, after virtualizing a physical device into a leaf device, the virtualization controller may select a physical interface of the leaf device as a user network interface (UNI) of the virtual device. The virtualization controller may select one or plural physical interfaces of the leaf device, and each of the selected one or plural physical interfaces may serve as a UNI of the virtual device.

The leaf device refers to a device providing a user with access to the network, and serves as an interface of the virtual device to users. The leaf device may receive packets sent by the user, and forward the packets to the root device. The leaf device may also receive packets from the root device, and distribute the packets to respective recipients. The user herein may refer to a device that expects to access the network, and perform communications using the network.

The UNI refers to a physical interface on a leaf device, and is directly connected to a user as an interface to access the network.

At block 103. the virtualization controller may obtain a UNI on the leaf device, establish a virtual interface on the root device for the UNI. and record a relation which associates the UNI with the virtual interface. The virtualization controller may establish a virtual interface on the root device for each UNI on each leaf device.

At block 104, the virtualization controller may control the root device and the leaf device to establish a virtual tunnel between the UNI and the virtual interface so that the root device and the leaf device may exchange data through the virtual tunnel. The virtualization controller may control the root device and each leaf device to establish a virtual tunnel between each UNI on each leaf device and a virtual interface corresponding to the UNI on the root device.

The virtualization controller is a centralized control node set up in a network. In an example, the virtualization controller may be a standalone physical device. In another example, the virtualization controller may be a module within a network device. In an example, the virtualization controller may be implemented by machine-readable instructions, e.g., X86 architectures-based instructions. In another example, the virtualization controller may be implemented by dedicated permanent circuits or logic (e.g., a dedicated processor, Field Programmable Gate Array (FPGA) or Application Specific Integrated Circuit (ASIC)).

The physical device may be a network device at any logical network position, e.g., a router, a switch, or the like. The virtual tunnel refers to a point-to-point tunnel for data transmission between the root device and the leaf device. Node devices (i.e., intermediate nodes) on the virtual tunnel may forward data packets to the next hop in the virtual tunnel according to a tunnel packet header of the data packets. In an example, a node device may forward a data packet according to information such as a tunnel identity, a forwarding tag, or the like, in the tunnel packet header of the data packet.

In an example, the virtual tunnel may be a multi-protocol label switching (MPLS)-based layer-2 virtual private network (L2 VPN) tunnel, or an IP-based virtual extensible local area network (VxLAN) tunnel, or a 802.1br tunnel, or a virtual local area network (VLAN)-based Q-in-Q (QINQ. also referred to as stacked VLAN, double VLAN, tag in tag) tunnel, and the like.

In an example, the virtualization controller may control the root device and the leaf device to establish a virtual tunnel between the UNI and the virtual interface according to the following process.

1) The virtualization controller may send a virtual tunnel protocol enabling command to each of the leaf device having the UNI, the root device having the virtual interface, and intermediate devices that are traversed by packets exchanged between the UNI and the virtual interface. The virtual tunnel protocol enabling command may include a virtual tunnel protocol identity, so that the leaf device, the root device and the intermediate device may enable a virtual tunnel protocol corresponding to the virtual tunnel protocol identity in the command.

2) The virtualization controller may send a virtual tunnel establishment command to each of the leaf device and the root device. The virtual tunnel establishment command sent to the leaf device may include an identity of the UNI and configuration information of the virtual tunnel, so that the leaf device may configure the virtual tunnel on the UNI according to the virtual tunnel establishment command. The virtual tunnel establishment command sent to the root device may include an identity of the virtual interface and configuration information of the virtual tunnel, so that the root device may configure the virtual tunnel on the virtual interface according to the virtual tunnel establishment command.

According to the above example, network virtualization can cover a larger range in a network. That is, devices in a larger network range, e.g., a range from network edge devices to devices close to the forwarding core of the network, may be virtualized into a virtual device. As such, the virtual device can remarkably increase the data forwarding efficiency in the network.

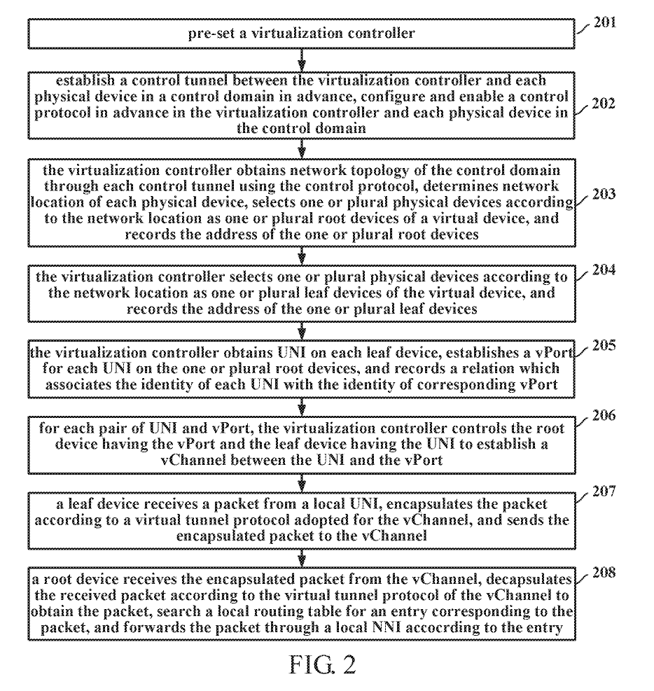

FIG. 2 is a flowchart illustrating a network virtualization method in accordance with an example of the present disclosure. The method may include the following procedures.

At block 201. a virtualization controller may be set up.

At block 202, a control tunnel may be established between the virtualization controller and each of physical devices within a control domain of the virtualization controller. A control protocol may be configured and enabled in the virtualization controller and each of the physical devices in the control domain. The control domain refers to a portion of the network that may be virtualized by the virtualization controller.

At block 203, the virtualization controller may obtain the network topology of the control domain via a control tunnel using a control protocol, determine the position of each physical device in the network according to the network topology, select one or plural physical devices according to the positions of the physical devices as one or plural root devices of the virtual device, and record the address of each root device.

At block 204, the virtualization controller may select one or plural physical devices in the control domain according to locations of the physical devices in the network as leaf devices of the virtual device, and record the address of each leaf device.

At block 205, the virtualization controller may obtain information of a UNI on a leaf device from the leaf device, establish a virtual port (vPort) on the root device for the UNI, and record a relation which associates the identity of the UNI with the identity of the vPort.

At block 206, the virtualization controller may control the root device and the leaf device to establish a virtual tunnel (also referred to as vChannel herein) between the UNI and the vPort. A vChannel may be established for each pair of UNI and vPort.

At block 207, after receiving a data packet from a UNI, the leaf device may encapsulate the data packet according to the virtual tunnel protocol used by the vChannel, and send the encapsulated packet to the vChannel.

For example, if the virtual tunnel protocol is MPLS, the leaf device may encapsulate the data packet according to the MPLS protocol.

At block 208, after receiving the encapsulated packet from the vChannel, the root device may decapsulate the packet according to the virtual tunnel protocol of the vChannel to obtain the original data packet. The root device may search a local routing table for an entry matching the packet, and forward the data packet through a local network node interface (NNI) according to the entry.

The NNI may refer to a physical interface on a root device, connected to another device in the network, and is for sending and receiving information exchanged between the virtual device and the network.

The control tunnel refers to a tunnel for transmitting control information between the virtualization controller and a physical device. The control tunnel may be established through a data communication network (DCN) self-establish mechanism of an Internet Protocol radio access network (IPRAN). In an example, the control tunnel may be manually configured in the virtualization controller and each physical device in the control domain.

In an example, the control protocol may be: simple network management protocol (SNMP), or software defined network (SDN), or NetConf protocol, or IEEE 802.1br control protocol, or the like. In an example, the control protocol may be a private protocol.

The procedure in block 203 may be implemented as follows.

The control domain may include physical devices selected according to the control requirements. In an example, the control domain may be manually configured in the virtualization controller. In another example, the control domain may be configured in each physical device in the control domain. In an example, the virtualization controller may obtain information of the control domain from a configuration file. The virtualization controller may obtain the configuration file from a pre-determined location. In an example, the location may be a module in the virtualization controller. In another example, the location may be a URL pointing to a device in the network. The virtualization controller may obtain the configuration file via wired or wireless connections, e.g., through a communication network. In an example, the configuration file may include information of each physical device in the control domain. In an example, the information of a physical device may include information selected from a group including: an address of the physical device, a device name, a hardware identity, and the like. In an example, the configuration file may also include information of the role of each physical device. The role of a physical device may include: root node, leaf node, intermediate node, or the like.

After startup, the virtualization controller may obtain the network topology of the control domain as follows.

In an example, the IP address of the virtualization controller may be configured in advance in each physical device in the control domain. A physical device may discover a connection relation with another physical device using a topology discovery protocol after startup, and report the connection relation to the virtualization controller through a control tunnel. The virtualization controller may receive connection relations between the physical devices reported by the physical devices, and thus obtain the network topology of the whole control domain.

In an example, the topology discovery protocol may be: the link layer discovery protocol (LLDP), the improved open shortest path first (OSPF) protocol, the intermediate system to intermediate system (ISIS) protocol, or the like.

In an example, the virtualization controller may discover the network topology of the control domain in a self-initiative manner. For example, when the virtualization controller and physical devices in the control domain all support the software defined network (SDN) protocol, e.g., the OpenFlow protocol, the virtualization controller may discover the network topology of the control domain using the LLDP for SDN.

In an example, when selecting one or plural physical devices as the root devices of the virtual device, the virtualization controller may select a physical device located in the convergence layer or the core layer as the root device of the virtual device. That is, a physical device located in proximity to the network forwarding core (i.e., the most distant to users) may be selected as the root device. In an example, information of a root device may be configured manually in the virtualization controller in advance. In another example, the virtualization controller may obtain information of the root device from the configuration file.

In an example, when there are plural physical devices each serving as a root device, the plural physical devices may be virtualized into one logical root device. The root device herein may refer to a physical device which is the one or the one of the plural physical devices forming the logical root device.

The procedure in block 204 may be implemented as follows.

In an example, the virtualization controller may select an end device in the control domain as a leaf device of the virtual device. That is, a physical device in closest proximity to the user side in the control domain, e.g., an access device, may be selected as a leaf device.

In an example, information of a leaf device may be configured manually in the virtualization controller in advance. In another example, the virtualization controller may obtain information of the one or plural leaf devices from the configuration file.

The information of a physical device may be an address of the physical device, a name of the physical device, or the like. The address of the physical device may be an IP address, a MAC address, or the like.

When a leaf device has plural physical UNIs, the plural UNIs may belong to different virtual devices. In an example, a relation which associates an identity of a UNI on a leaf device with an identity of a virtual device may be configured manually in the virtualization controller. In another example, the relation may be obtained by the virtualization controller from the configuration file.

The procedure in block 205 may be implemented as follows.

When all of UNIs on a leaf device belong to one virtual device, the virtualization controller may obtain information of the UNIs on the leaf device as in the following examples.

In an example, the virtualization controller may actively acquire information of all UNIs on a leaf device via a control tunnel using a control protocol.

In an example, a physical device in the control domain may actively report information of all UNIs on the physical device to the virtualization controller via a control tunnel using the control protocol. The virtualization controller may store a relation which associates the address of each physical device and information of UNI on the physical device. The virtualization controller may obtain information of a UNI from the relations according to the address of the leaf device.

If UNIs on a leaf device belong to plural virtual devices, the virtualization controller may obtain a relation which associates information of a UNI on a leaf device with an identity of a virtual device from a configuration file. The virtualization controller may obtain information of a UNI belonging to the virtual device from a leaf device.

The procedure in block 206 may be implemented as follows.

The vChannel may be used for transporting data between the vPort and the UNI.

The vChannel may be an MPLS-based L2 VPN tunnel, or an IP-based VxLAN tunnel, or a 802.1br tunnel, or a VLAN-based QINQ tunnel, or the like.

In an example, the process of establishing a vChannel may include the following procedures.

When the virtualization controller is to establish a vChannel between a UNI and a vPort, the virtualization controller may select a virtual tunnel protocol supported by a leaf device having the UNI, the root device having the vPort and all of intermediate devices connecting the UNI with the vPort, and send a virtual tunnel protocol enabling command which includes an identity of the selected virtual tunnel protocol to the leaf device, the root device and all of the intermediate devices via control tunnels.

The leaf device, the root device and all of the intermediate devices may receive the virtual tunnel protocol enabling command, and enable the virtual tunnel protocol according to the identity of the virtual tunnel protocol in the command.

The virtualization controller may send a vChannel establishment command to each of the leaf device and the root device. The vChannel establishment command sent to the leaf device may include the identity of the UNI and configuration information of the virtual tunnel. The vChannel establishment command sent to the root device may include the identity of the vPort and configuration information of the virtual tunnel.

In an example, each physical device in the control domain may report a set of virtual tunnel protocols supported by the physical device to the virtualization controller via the control tunnel actively after startup. In an example, the virtualization controller may select the virtual tunnel protocol from the sets of supported virtual tunnel protocols of the leaf device, the root device and all of the intermediate devices.

In an example, the virtualization controller and all of physical devices in the control domain may be configured with the same set of supported virtual tunnel protocols. The virtualization controller may select a virtual tunnel protocol from the set configured in the virtualization controller as the virtual tunnel protocol to be used.

After startup, a physical device may report various types of information to the virtualization controller via the control tunnel. In an example, the physical device may send the various types of information in one packet. In another example, the physical device may send the various types of information in plural packets which are sent to the virtualization controller one after another. The information reported to the virtualization controller may be selected from a group including: a connection relation between the physical device with another device, information of a UNI on the physical device, the set of virtual tunnel protocols supported by the physical device, and the like.

The leaf device may receive the vChannel establishment command, and configure the virtual tunnel at the UNI according to the identity of the UNI in the vChannel establishment command and the configuration information of the virtual tunnel. The root device may receive the vChannel establishment command, and configure the virtual tunnel at the vPort according to the identity of the vPort in the vChannel establishment command and the configuration information of the virtual tunnel. In an example, the configuration information of the virtual tunnel may include a tunnel identity, or a forwarding tag, or the like.

For example, if the virtual tunnel protocol is MPLS, the vChannel establishment command may include information of a L2 VPN instance as the configuration information of the virtual tunnel. The leaf device may bind the L2VPN instance with the UNI according to the information of the L2VPN instance and the identity of the UNI after receiving the vChannel establishment command. The root device may bind the L2VPN instance with the vPort according to the information of the L2VPN instance and the identity of the vPort after receiving the vChannel establishment command. For example, if the virtual tunnel protocol is VxLAN, the vChannel establishment command may include information of a VxLAN as the configuration information of the virtual tunnel. The leaf device may bind the VxLAN with the UNI according to the information of the VxLAN and the identity of the UNI after receiving the vChannel establishment command. The root device may bind the VxLAN with the vPort according to the information of the VxLAN and the identity of the vPort after receiving the vChannel establishment command.

In an example, the virtualization controller may send a vChannel establishment command to an intermediate device. The vChannel establishment command may include configuration information of the virtual tunnel and path information of the virtual tunnel. The path information of the virtual tunnel may include information of the next hop to forward a packet received from the virtual tunnel by the intermediate device. For example, the path information of the virtual tunnel in the direction from the leaf device to the root device may include: information of a next hop device, information of an egress port of the intermediate device, information of a root device, or the like.

In an example, the leaf device and/or the root device may send a virtual tunnel establishment command to an intermediate device after configuring the virtual tunnel in the leaf device and/or the root device. The virtual tunnel establishment command may be forwarded along the path of the virtual tunnel to all of intermediate devices. The intermediate devices may establish the virtual tunnel according to the virtual tunnel protocol. The virtual tunnel establishment command may include information of the path of the virtual tunnel. The information of the path may include information such as all of intermediate devices on the path, information of the next hop of each intermediate devices, and the like. In an example, the information of the path may be obtained by the leaf device and/or the root device from the virtualization controller. In an example, the virtualization controller may send the information of the path to the leaf device or the root device via a vChannel establishment command. The information of the path may be sent to the leaf device or the root device in another message. In another example, the information of the path may be obtained by the leaf device and/or the root device by using a path calculation algorithm, e.g., shortest path first (SPF), or the like. In this example, the virtualization controller may send information of one of the leaf device and the root device to the other of the leaf device and the root device. The intermediate devices may be determined by the root device and/or the leaf device by calculating the path between the root device and the leaf device.

The procedure in block 208 may be implemented as follows.

If the root device does not find the entry matching the data packet in the local routing table, the root device may forward the data packet according to a default routing table entry if there is a default routing table, or discard the data packet if there is no default routing table entry.

If the root device is a logical device including plural physical devices, the packet received from a vChannel may be processed by one of the physical devices determined as follows.

In an example, it may be pre-defined that all packets received from a vChannel are processed by a primary device of the plural root devices. If a device receiving the packet detects the device is not the primary device, the device may send the packet to the primary device.

In another example, the packet received from a vChannel may be processed by the device that receives the packet.

After receiving an encapsulated packet from the vChannel, the leaf device may decapsulate the packet, and send the decapsulated packet through the UNI.

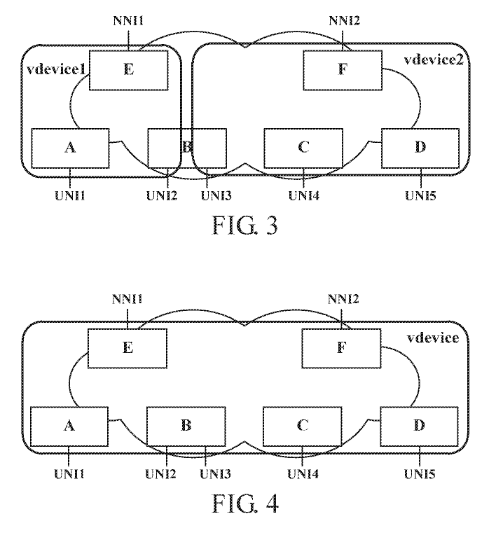

FIG. 3 is a schematic diagram illustrating virtual devices in accordance with an example of the present disclosure. The process of establishing the virtual devices may include the following procedures.

A control tunnel may be established in advance in a virtualization controller and physical devices in a control domain of the virtualization controller. The IP address of the virtualization controller may be configured in the physical devices in the control domain. A control protocol, e.g., SNMP, and a virtual tunnel protocol, e.g., MPLS, may be configured in the virtualization controller and the physical devices.

After startup, a physical device may report a connection relation between the physical device and another physical device and information of a UNI on the physical device through the virtual tunnel using the SNMP. The virtualization controller may obtain the network topology of the control domain according to connection relations reported by all of the physical devices.

The virtualization controller may determine to establish virtual device 1 (Vdevice1).

The virtualization controller may select a root device, i.e., physical device E, for Vdevice1 according to the network topology of the control domain.

The controller may specify an NNI on the root device of Vdevice1, i.e., NNI1 on physical device E. In an example, the controller may select one of physical interfaces on the root device as an NNI.

The virtualization controller may select leaf devices, i.e., physical devices A and B, for Vdevice1 according to the network topology of the control domain.

The virtualization controller may establish UNIs, i.e., UNI1 on physical device A and UNI2 on physical device B, on the leaf devices of Vdevice1 according to information of UNIs reported by physical devices A and B.

The virtualization controller may establish two vPorts, i.e., vPort1 and vPort2, on root device E for UNI1 and UNI2. vPort 1 is corresponding to UNI1, and vPort2 is corresponding to UNI2.

The virtualization controller may establish vChannel1 between UNI1 and vPort1, and send MPLS protocol enabling commands to root device E, leaf device A and all of intermediate devices.

The root device E, the leaf device A and all of the intermediate devices receive the MPLS protocol enabling commands, and enable the MPLS protocol.

The virtualization controller may send to root device E a first vChannel establishment command which includes the identity of vPort1 and information of a L2VPN instance, and send to leaf device A second vChannel establishment command which includes the identity of UNI1 and information of the L2VPN instance.

Root device E may bind the information of the L2VPN in the first vChannel establishment command with vPort1 after receiving the first vChannel establishment command. Leaf device A may bind the information of the L2VPN in the second vChannel establishment command with UNI1 after receiving the second vChannel establishment command.

The virtualization controller may establish vChannel2 between UNI2 and vPort2 in a similar process.

After receiving a data packet from UNI1, leaf device A may encapsulate the data packet according to an encapsulation method defined in the virtual tunnel protocol of vChannel1, i.e., MPLS, and send the encapsulated packet to vChannel1.

Root device E receives the encapsulated packet from vPort1, decapsulate the packet according to a decapsulation method defined in MPLS protocol which is the virtual tunnel protocol of vChannel1 to obtain the original data packet, search in root device E for a routing table entry corresponding to the data packet, and forward the data packet according to the routing table entry.

The virtualization controller may establish vDevice2 in the same manner as establishing vDevice1.

As such, physical devices in a control domain may be virtualized into plural virtual devices (as shown in FIG. 3), or may be virtualized into one virtual device (as shown in FIG. 4). Different interfaces on a physical device may belong to different virtual devices. That is, a physical device may belong to different virtual devices, but an interface of a physical device may belong to only one virtual device.

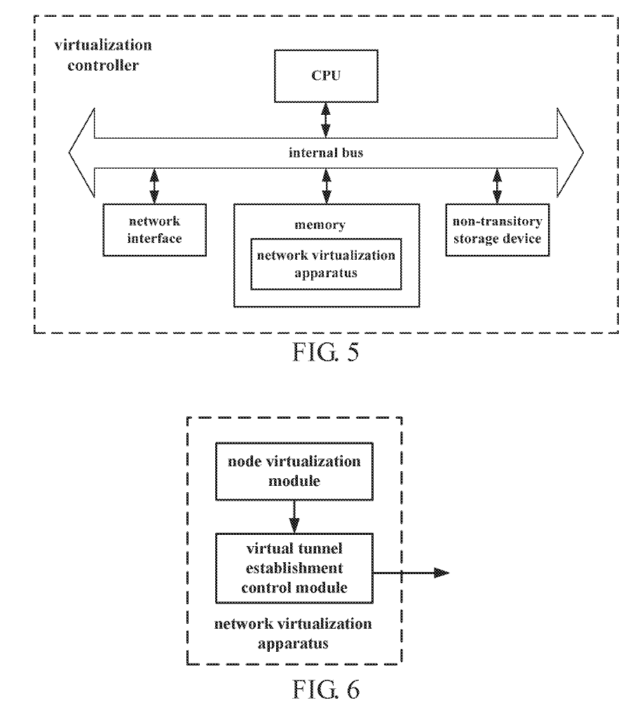

FIG. 5 is a schematic diagram illustrating a structure of a virtualization controller which includes a network virtualization apparatus in accordance with an example of the present disclosure. The virtualization controller may include a CPU, a non-transitory storage device, and a memory.

The non-transitory storage device may store instructions. The instructions may be executed by the CPU to make the network virtualization apparatus in the memory to implement various functions.

The CPU may communicate with the non-transitory storage device, read and execute the instructions in the non-transitory storage device to make the network virtualization apparatus to implement the functions.

The memory may include the network virtualization apparatus which may implement various functions when the instructions in the non-transitory storage device are executed.

As shown in FIG. 6, the network virtualization apparatus may include: a node virtualization module and a virtual tunnel establishment control module.

The node virtualization module may select a physical device as a root device of a virtual device, and select a physical device as a leaf device of the virtual device. The node virtualization module may select plural physical devices each of which may serve as a root device, and select plural physical devices each of which may serve as a leaf device.

The virtual tunnel establishment module may obtain a UNI on the leaf device, establish a virtual interface on the root device for the UNI, and record a relation which associates the UNI with the virtual interface. The virtual tunnel establishment module may control the root device and the leaf device to establish a virtual tunnel between the UNI and the virtual interface so that the root device and the leaf device may exchange data through the virtual tunnel.

The virtual tunnel may be an MPLS-based L2 VPN tunnel, or an IP-based VxLAN tunnel, or a 802.1br tunnel, or a VLAN-based QINQ tunnel.

The node virtualization module may select a physical interface of the leaf device as a UNI of the virtual device. The node virtualization module may select plural physical interfaces of the leaf device as plural UNIs of the virtual device.

The virtual tunnel establishment control module may send a virtual tunnel protocol enabling command to each of the leaf device having the UNI. the root device having the virtual interface and intermediate devices connecting the UNI with the virtual interface, so that the leaf device, the root device and the intermediate devices enable the virtual tunnel protocol according to the virtual tunnel protocol enabling command. The virtual tunnel protocol enabling command may include an identity of the virtual tunnel protocol. The virtual tunnel establishment control module may send a first virtual tunnel establishment command to the leaf device. The first virtual tunnel establishment command may include an identity of the UNI and configuration information of a virtual tunnel. The leaf device may configure the virtual tunnel on the UNI according to the first virtual tunnel establishment command. The virtual tunnel establishment control module may send a second virtual tunnel establishment command to the root device. The second virtual tunnel establishment command may include an identity of the virtual interface and configuration information of the virtual tunnel. The root device may configure the virtual tunnel on the virtual interface according to the second virtual tunnel establishment command.

The network virtualization apparatus may be a logical apparatus formed when the CPU reads the instructions stored in the non-transitory storage and executes the instructions in the memory. When the instructions are executed, the network virtualization apparatus is formed and perform operations to implement the network virtualization method of various examples.

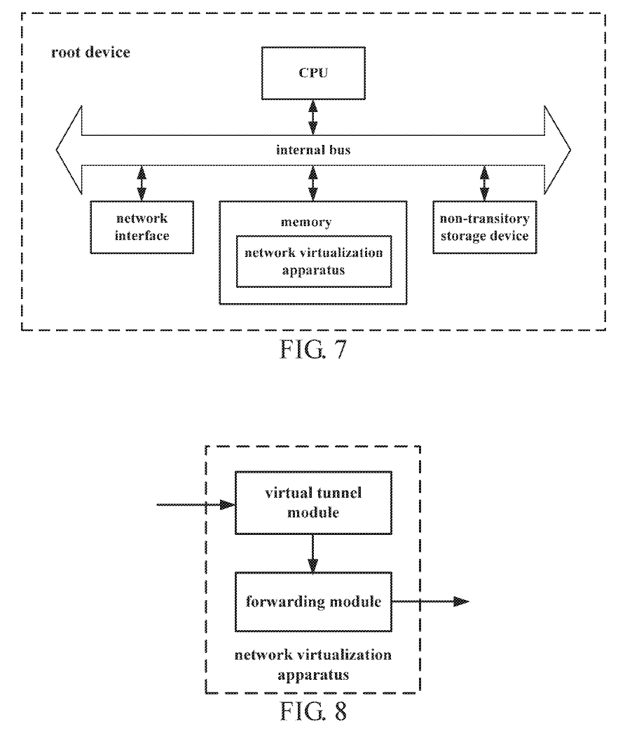

The root device may be a device implemented by a processor and instructions. FIG. 7 is a schematic diagram illustrating a structure of a root device which includes a network virtualization apparatus in accordance with an example of the present disclosure. The root device may include a CPU, a non-transitory storage device, and a memory.

The memory may include the network virtualization apparatus which may implement various functions when the instructions in the non-transitory storage device are executed.

The CPU may communicate with the non-transitory storage device, read and execute the instructions in the non-transitory storage device to make the network virtualization apparatus to implement the functions.

The memory may include the network virtualization apparatus which may implement various functions when the instructions in the non-transitory storage device are executed.

As shown in FIG. 8, the network virtualization apparatus in the root device may include: a virtual tunnel module and a forwarding module.

The virtual tunnel module may receive a virtual tunnel protocol enabling command sent by a virtualization controller, and enable a virtual tunnel protocol according to an identity of the virtual tunnel protocol in the virtual tunnel protocol enabling command. The virtual tunnel module may receive a virtual tunnel establishment command sent by the virtualization controller, and configure a virtual tunnel on an interface according to an identity of the interface and configuration information of the virtual tunnel in the virtual tunnel establishment command. The virtual tunnel module may receive a packet from the virtual tunnel, decapsulate the packet to obtain an original packet, and provide the original packet for the forwarding module.

The forwarding module may obtain the original packet provided by the virtual tunnel module, search a routing table for an entry corresponding to the original packet, and forward the original packet through an NNI according to the entry.

The network virtualization apparatus may be a logical apparatus formed when the CPU reads the instructions stored in the non-transitory storage and executes the instructions in the memory. When the instructions are executed, the network virtualization apparatus is formed and perform operations to implement the network virtualization method of various examples.

According to various examples, the virtualization controller may virtualize a control domain into a virtual device.

The virtual device implements flexible network virtualization, e.g., network resources in a control domain may be virtualized into one or plural virtual devices.

The virtual tunnels between root devices and leaf devices may be implemented using various manners, including but not limited to, MPLS-based L2 VPN tunnel, IP-based VxLAN tunnel, 802.1br tunnel, VLAN-based QINQ tunnel, thus can accommodate virtual tunnels in-use in the network. In an example, VxLAN-based overlay tunnels can enable a virtual device to overlay on a third-party network, thus the virtual device can obtain better extensibility.

Various examples also provide a machine-readable storage medium. The storage medium may be non-transitory, and may include instructions executable by a machine to:
select a physical device as a root device of a virtual device;
select a physical device as a leaf device of the virtual device;
obtain a user network interface (UNI) on the leaf device, establish a virtual interface on the root device for the UNI, and record a relation which associates the UNI with the virtual interface; and
control the root device and the leaf device to establish a virtual tunnel between the UNI and the virtual interface through which the root device and the leaf device exchange data.

In an example, the instructions executable by a machine to control the root device and the leaf device to establish a point-to-point packet forwarding tunnel as the virtual tunnel.

In an example, the instructions executable by a machine to control the root device and the leaf device to establish the virtual tunnel which is a multi-protocol label switching (MPLS)-based layer-2 virtual private network (L2 VPN) tunnel, or an IP-based virtual extensible local area network (VxLAN) tunnel, or a 802.1br tunnel, or a virtual local area network (VLAN)-based Q-in-Q (QINQ) tunnel.

In an example, the instructions executable by a machine to:
select a UNI belonging to the virtual device according to a relation which associates the UNI with an identity of the virtual device.

In an example, the instructions executable by a machine to:
send a virtual tunnel protocol enabling command to each of the leaf device having the UNI, the root device having the virtual interface, and intermediate devices connecting the UNI with the virtual interface, wherein the virtual tunnel protocol enabling command comprises an identity of a virtual tunnel protocol according to which the leaf device, the root device and the intermediate devices enable the virtual tunnel protocol; and
send a first virtual tunnel establishment command to the leaf device, the first virtual tunnel establishment command comprises an identity of the UNI and configuration information of the virtual tunnel according to which the leaf device configures the virtual tunnel on the UNI; send a second virtual tunnel establishment command to the root device, the second virtual tunnel establishment command comprises an identity of the virtual interface and configuration information of the virtual tunnel according to which the root device configures the virtual tunnel on the virtual interface.

According to various examples, network virtualization can cover a larger range in a network. That is, devices in a larger network range, e.g., a range from network edge devices to devices close to the forwarding core of the network, may be virtualized into a virtual device. As such, the virtual device can remarkably increase the data forwarding efficiency in the network.

The foregoing description, for the purposes of explanation, has been described with the reference to specific examples. However, the illustrative discussions above are not intended to be exhaustive or to limit the present disclosure to the precise forms disclosed. Many modifications and variations are possible in view of the above teachings. The examples were chosen and described in order to best explain the principles of the present disclosure and its practical applications, to thereby enable others skilled in the art to best utilize the present disclosure and various examples with various modifications which are suited to the particular use contemplated.

1. A network virtualization method, comprising:
selecting, by a virtualization controller, a physical device as a root device of a virtual device;
selecting, by the virtualization controller, a physical device as a leaf device of the virtual device;
obtaining, by the virtualization controller, a user network interface (UNI) on the leaf device, establishing a virtual interface on the root device for the UNI, and recording a relation which associates the UNI with the virtual interface; and
controlling, by the virtualization controller, the root device and the leaf device to establish a virtual tunnel between the UNI and the virtual interface through which the root device and the leaf device exchange data.

2. The method of claim 1, wherein the virtual tunnel is a point-to-point packet forwarding tunnel.

3. The method of claim 2, wherein the virtual tunnel is a multi-protocol label switching (MPLS)-based layer-2 virtual private network (L2 VPN) tunnel, or an IP-based virtual extensible local area network (VxLAN) tunnel, or a 802.1br tunnel, or a virtual local area network (VLAN)-based Q-in-Q (QINQ) tunnel.

4. The method of claim 1, wherein obtaining by the virtualization controller the UNI on the leaf device comprises:
selecting, by the virtualization controller, a UNI belonging to the virtual device according to a relation which associates the UNI with an identity of the virtual device.

5. The method of claim 1, wherein controlling by the virtualization controller the root device and the leaf device to establish the virtual tunnel between the UNI and the virtual interface comprises:
sending, by the virtualization controller, a virtual tunnel protocol enabling command to each of the leaf device having the UNI, the root device having the virtual interface, and intermediate devices connecting the UNI with the virtual interface, wherein the virtual tunnel protocol enabling command comprises an identity of a virtual tunnel protocol according to which the leaf device, the root device and the intermediate devices enable the virtual tunnel protocol; and
sending, by the virtualization controller, a first virtual tunnel establishment command to the leaf device, the first virtual tunnel establishment command comprises an identity of the UNI and configuration information of the virtual tunnel according to which the leaf device configures the virtual tunnel on the UNI; sending, by the virtualization controller, a second virtual tunnel establishment command to the root device, the second virtual tunnel establishment command comprises an identity of the virtual interface and configuration information of the virtual tunnel according to which the root device configures the virtual tunnel on the virtual interface.

6. A virtualization controller, comprising a processor and a storage device, wherein the storage device stores machine-readable instructions executable by the processor to:
select a physical device as a root device of a virtual device, select a physical device as a leaf device of the virtual device;
obtain a user network interface (UNI) on the leaf device, establish a virtual interface on the root device for the UNI, and record a relation which associates the UNI with the virtual interface, control the root device and the leaf device to establish a virtual tunnel between the UNI and the virtual interface through which the root device and the leaf device exchange data.

7. The virtualization controller of claim 6, wherein the instructions are executable by the processor to:
control the root device and the leaf device to establish a point-to-point packet forwarding tunnel between the UNI and the virtual interface as the virtual tunnel.

8. The virtualization controller of claim 7, wherein the instructions are executable by the processor to:
establish one of a multi-protocol label switching (MPLS)-based layer-2 virtual private network (L2 VPN) tunnel, an IP-based virtual extensible local area network (VxLAN) tunnel, a 802.1br tunnel, a virtual local area network (VLAN)-based Q-in-Q (QINQ) tunnel as the virtual tunnel.

9. The virtualization controller of claim 6, wherein the instructions are executable by the processor to:
select the UNI of the leaf device according to a relation which associates the UNI with an identity of the virtual device as the UNI of the virtual device.

10. The virtualization controller of claim 6, wherein the instructions are executable by the processor to:
send a virtual tunnel protocol enabling command to each of the leaf device having the UNI, the root device having the virtual interface, and intermediate devices connecting the UNI with the virtual interface, wherein the virtual tunnel protocol enabling command comprises an identity of a virtual tunnel protocol according to which the leaf device, the root device and the intermediate devices enable the virtual tunnel protocol; and
send a first virtual tunnel establishment command to the leaf device, the first virtual tunnel establishment command comprises an identity of the UNI and configuration information of the virtual tunnel according to which the leaf device configures the virtual tunnel on the UNI; send a second virtual tunnel establishment command to the root device, the second virtual tunnel establishment command comprises an identity of the virtual interface and configuration information of the virtual tunnel according to which the root device configures the virtual tunnel on the virtual interface.

11. A machine-readable storage medium, comprising instructions executable by a machine to:
select a physical device as a root device of a virtual device;
select a physical device as a leaf device of the virtual device;
obtain a user network interface (UNI) on the leaf device, establish a virtual interface on the root device for the UNI, and record a relation which associates the UNI with the virtual interface; and
control the root device and the leaf device to establish a virtual tunnel between the UNI and the virtual interface through which the root device and the leaf device exchange data.

12. The machine-readable storage medium of claim 11, wherein the instructions executable by a machine to control the root device and the leaf device to establish a point-to-point packet forwarding tunnel as the virtual tunnel.

13. The method of claim 12, wherein the instructions executable by a machine to control the root device and the leaf device to establish the virtual tunnel which is a multi-protocol label switching (MPLS)-based layer-2 virtual private network (L2 VPN) tunnel, or an IP-based virtual extensible local area network (VxLAN) tunnel, or a 802.1br tunnel, or a virtual local area network (VLAN)-based Q-in-Q (QINQ) tunnel.

14. The method of claim 11, wherein the instructions executable by a machine to:
select a UNI belonging to the virtual device according to a relation which associates the UNI with an identity of the virtual device.

15. The method of claim 11, wherein the instructions executable by a machine to:
send a virtual tunnel protocol enabling command to each of the leaf device having the UNI, the root device having the virtual interface, and intermediate devices connecting the UNI with the virtual interface, wherein the virtual tunnel protocol enabling command comprises an identity of a virtual tunnel protocol according to which the leaf device, the root device and the intermediate devices enable the virtual tunnel protocol; and
send a first virtual tunnel establishment command to the leaf device, the first virtual tunnel establishment command comprises an identity of the UNI and configuration information of the virtual tunnel according to which the leaf device configures the virtual tunnel on the UNI; send a second virtual tunnel establishment command to the root device, the second virtual tunnel establishment command comprises an identity of the virtual interface and configuration information of the virtual tunnel according to which the root device configures the virtual tunnel on the virtual interface.
